(19) United States
(12) Patent Application Publication
(10) Pub. No.: US 2016/0175747 A1
(43) Pub. Date: Jun. 23, 2016

(54) BUCKET EXTENSION

(71) Applicant: Don Charleston, Maxwell, IA (US)

(72) Inventor: Don Charleston, Maxwell, IA (US)

(21) Appl. No.: 14/967,891

(22) Filed: Dec. 14, 2015

Related U.S. Application Data
(60) Provisional application No. 62/094,159, filed on Dec. 19, 2014.

(51) Int. Cl. B01D 35/30; B65D 25/20

(52) U.S. Cl. CPC B01D 35/306; B65D 25/20

(57) ABSTRACT

A bucket having a ring and a plurality of legs attached to the ring and extend downwardly. The legs terminate in a hook that is formed to receive a rim of a bucket. The ring is formed to receive an underneath lip of a filter. The legs create a space between the filter and the rim of the bucket.

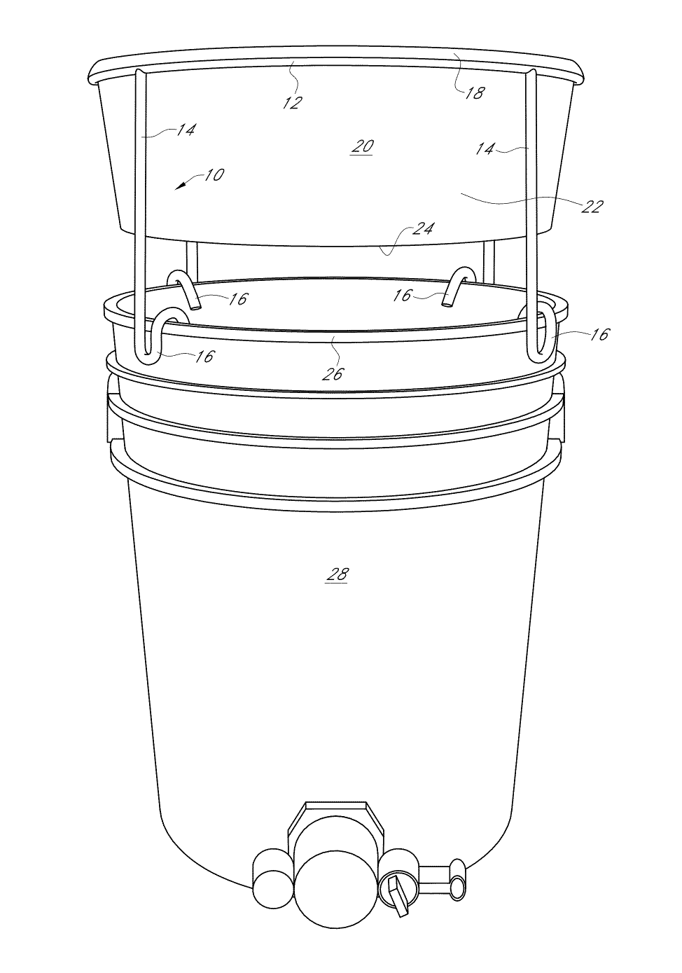

### CROSS-REFERENCE TO RELATED APPLICATIONS

This application claims priority to Provisional Application U.S. Ser. No. 62/094,159 filed on Dec. 19, 2014, which is herein incorporated by reference in its entirety

### BACKGROUND OF THE INVENTION

This invention is directed to a bucket extension and more particularly to a bucket extension for filtering material into a bucket.

Filtering material into a bucket is known in the art. Typically, a lip of a filter is supported by the rim of the bucket such that the filter extends down into the bucket. While this allows material, such as honey, to be filtered, one is not able to see the fill level of the bucket and must repeatedly lift the filter to see how much material is in the bucket. Also, because the filter extends into the bucket, time and effort is needed to remove the filter and top off the bucket after filtering.

Thus, a need exists in the art for a device that addresses these deficiencies.

### SUMMARY OF THE INVENTION

A bucket having a ring and a plurality of legs attached to the ring and extend downwardly. The legs terminate in a hook that is formed to receive a rim of a bucket. The ring is formed to receive an underneath lip of a filter. The legs create a space between the filter and the rim of the bucket.

An objective of the invention is to provide a bucket extension that permits one to see a fill level within the bucket while the bucket is filled with material.

Another objective of the present invention is to provide a bucket extension that reduces the time and effort to filter material into a bucket.

These and other objectives will be apparent to those skilled in the art based upon the following written description, drawings and claims.

### BRIEF DESCRIPTION OF THE DRAWING

The FIGURE is a perspective view of a bucket extension.

### DETAILED DESCRIPTION OF THE PREFERRED EMBODIMENT

Referring to the FIGURES, a bucket extension 10 has a ring 12 with a plurality of legs 14 that extend downwardly from the ring 12. Each leg 14 terminates in a hook 16 that preferably curve upwardly and inwardly.

The ring 12 is formed to be received underneath a lip 18 of a filter 20 having a sidewall 22 and a bottom screen 24. The hooks 16 of the legs 14 are formed to fit over a rim 26 of a bucket 28. The legs 14 are of sufficient length that a space exists between the bottom screen 24 of the filter 20 and the rim 26 of the bucket 28 such that the contents of the bucket 28 may be viewed during filling.

In operation, the extension 10 is placed on the bucket 28 such that the hooks 16 of the legs 14 fit over the rim 26 of the bucket 28. The filter 20 is placed within the ring 12 of the extension 10 such that the lip 18 engages the ring 12 and supports the filter 20. Material, such a honey, is then poured into the filter 20 and flows through the screened bottom 24 and into the bucket 28.

Accordingly, a bucket extension has been disclosed that saves on considerable time as the need for repeatedly checking to see if the bucket is full. Also, the height of the extension compensates for the depth of the filter and allows the bucket to be filled to the top.

What is claimed is:

1. A bucket extension, comprising:
a ring;
a plurality of legs extending downwardly from the ring; and
each of the plurality of legs terminating in a hook.

2. The extension of claim 1 wherein the hooks curve upwardly and inwardly.

3. The extension of claim 1 wherein the rings is formed to receive an underneath lip of a filter having a sidewall and bottom screen.

4. The extension of claim 1 wherein the hooks are formed to fit over a rim of a bucket.

5. The extension of claim 1 wherein the rim receives and supports a filter, the hooks receive a rim of a bucket, and the legs create a space between the filter and the rim of the bucket.
